(19) United States
(12) Patent Application Publication
(10) Pub. No.: US 2008/0126419 A1
(43) Pub. Date: May 29, 2008

(54) Method for providing file information according to selection of language and file reproducing apparatus using the same

(75) Inventor: Se-min Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/822,637

(22) Filed: Jul. 9, 2007

(30) Foreign Application Priority Data
Nov. 27, 2006 (KR) 2006-117755

(51) Int. Cl. G06F 17/30

(52) U.S. Cl. 707/104.1; 707/E17.101

(57) ABSTRACT

A method for providing a file according to the selection of a language, and a file reproducing apparatus using the method, are provided. The method includes reading a file name of a file stored in a record medium and recognizing a language of the read file name. A letter string is also restored from additional information on the file by referring to a language code table on the recognized language, and displaying the restored letter string. Accordingly, detailed information on a file is prevented from being provided in a letter string which can not be read and inconvenience of a user's selection of a language on the detailed information is resolved.

### CROSS-REFERENCE TO RELATED APPLICATIONS

This application claims the benefit under 35 U.S.C. § 119 of Korean Patent Application No. 2006-117755, filed on Nov. 27, 2006, in the Korean Intellectual Property Office (KIPO), the entire disclosure of which is hereby incorporated by reference.

### BACKGROUND OF THE INVENTION

1. Field of the Invention

The present invention relates to a method for providing file information and a file reproducing apparatus using the method. More particularly, the present invention relates to a method for providing file information such as detailed information on a file to a user and a file reproducing apparatus using the method.

2. Description of the Related Art

An MP3 player provides auditory entertainment to a user by reproducing an MP3 file and also provides a visual entertainment to the user by displaying detailed information on music recorded in the MP3 file which is being reproduced on an LCD. The detailed information on the displayed music includes the title of the music, the singer, the title of the album, and the year of production.

The detailed information on the music can be provided using ID3 tag information included in the MP3 file. That is, the detailed information on the music is provided to the user by restoring a letter string from the ID3 tag information and displaying the restored letter string on the LCD.

The ID3 tag information can be made using various languages (for example, English, Korean, and Japanese, among others). Therefore, language code tables for corresponding languages are provided to restore a letter string from the ID3 tag information. Then, a selected language code table to be used is set by a user. The user should set language information on the ID3 tag information through a menu screen provided in an MP3 player.

If a language is incorrectly set, the detailed information on the music is displayed in letter string format which cannot be read by a user. This happens because reference is made to an improper language code table in restoring a letter string from the ID3 tag information if a language is incorrectly set.

If the detailed information on the music is displayed in the state in which the detailed information cannot be read, a user should select the language of the ID3 tag information and should change the setting of the language on the ID3 tag information to the selected language. Further, the language which has been selected by a user cannot be assumed to be the language on the ID3 tag information.

Accordingly, there is a need for an improved system and method for providing file information according to selection of a language and for a file reproducing apparatus capable of preventing detailed information on a file from being provided in a letter string which cannot be read and thereby prevent an inconvenience to a user.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method for providing file information based on language and a file reproducing apparatus using the method. The method and apparatus can prevent detailed information on a file from being provided in a letter string which is not readable and can obviate the inconvenience of a user's selection of a language on the detailed information to solve the problem.

The above objects of the present invention are substantially realized by providing a method for providing file information. A file name of a file stored in a record medium is read. A language of the read file name is recognized. A letter string is restored from additional information on the file by referring to a language code table on the recognized language and the restored letter string is displayed.

The method may further comprise displaying the read file name as a title of contents recorded in the file.

According to an exemplary implementation, while a title is displayed, the read file name may be displayed as a title of the contents recorded in the file if a determination is made that there is not the additional information in the file.

If a determination is made that there is additional information in the file, the read file name and the title of the contents included in the additional information may be displayed as the title of the contents recorded in the file.

According to an exemplary implementation, the file name is coded in the Unicode system and the additional information on the file is information coded in the ISO-8859 code system.

Further, the file may be an audio file and the additional information on the file may be ID3 tag information.

During the language recognition of the file name, languages of the letters constituting the file name are determined and a language of the determined languages which excludes English is recognized as the language of the file name.

According to another aspect of the present invention, a file reproducing apparatus is provided. This file reproducing apparatus comprises a record medium interface, a display and a control section. The record medium accesses a record medium. The display displays information and the control section reads a file name of a file stored in a record medium through a record medium interface. The control section also recognizes a language of the read file name and restores a letter string from additional information on the file by referring to a language code table on the recognized language and displays the restored letter string.

Further, the control section may display the read file name on the display as a title of contents recorded in the file.

According to an exemplary implementation, if a determination is made that there is no additional information in the file, the control section may display the read file name as a title of the contents recorded in the file.

According to an exemplary implementation, if it is determined that there is the additional information in the file, the control section may display one of the read file name and the title of the contents included in the additional information on the display as the title of the contents recorded in the file.

It is preferable that the file name may be coded in the Unicode system and the additional information on the file may be information coded in the ISO-8859 code system.

Further, the file may be an audio file and the additional information on the file may be ID3 tag information.

The control section may determine languages of the letters constituting the file name and may recognize a language of the determined languages which excludes English as the language of the file name.

Other objects, advantages and salient features of the invention will become apparent to those skilled in the art from the following detailed description, which, taken in conjunction with the annexed drawings discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram of an audio file reproducing apparatus according to a preferred embodiment of the present invention; and

FIG. 2 is a flow chart for explaining a method for providing audio file information according to a preferred embodiment of the present invention.

Throughout the drawings, the same drawing reference numerals will be understood to refer to the same elements, features and structures.

### DETAILED DESCRIPTION OF THE PREFERRED EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

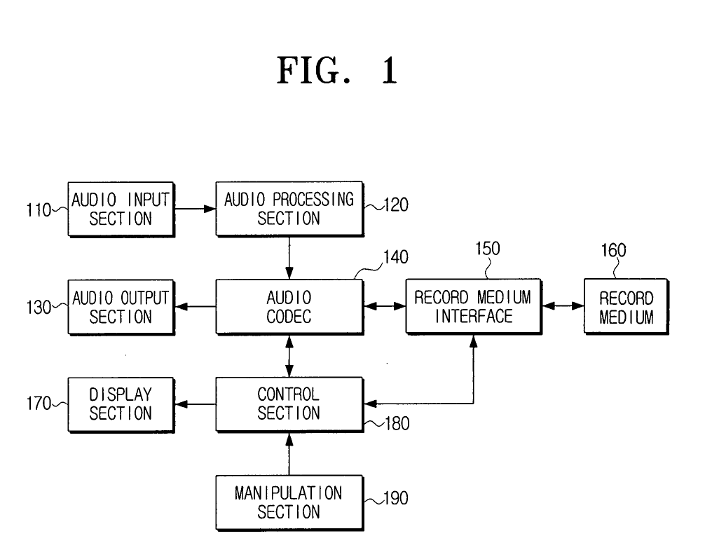

FIG. 1 is a block diagram of an audio file reproducing apparatus according to an exemplary embodiment of the present invention. The audio file reproducing apparatus, according to the exemplary embodiment of the present invention, is a file reproducing apparatus that can reproduce an audio file and provide the reproduced audio file to a user, and can provide detailed information of the audio file when the audio file is reproduced.

As illustrated in FIG. 1, the audio file reproducing apparatus (hereinafter, referred to as ‘reproducing apparatus’), according to the exemplary embodiment of the present invention, includes an audio input section 110, an audio processing section 120, an audio output section 130, an audio codec 140, a record medium interface 150, a record medium 160, a display section 170, a control section 180, and a manipulation section 190.

The audio input section 110 acquires audio signals by obtaining an external sound from an embedded microphone (not shown) or an external microphone (not shown) connected thereto. The audio processing section 120 converts analog audio signals output from the audio input section 110 to digital audio signals and transfers the converted digital signals to the audio codec 140.

The audio codec 140 compresses the audio signals output form the audio processing section 120 and transfers the compressed audio signals to the record medium interface 150.

The record medium interface 150 records the compressed audio signals which have been transferred from the audio codec 140 in the record medium 160 as an audio file. Further, the record medium interface 150 records the audio file received from an external device (for example, a PC and a mobile phone) through a USB (universal serial bus), Bluetooth, and an IEEE 1394 interface, among others in the record medium 160.

Further, the record medium interface 150 accesses the record medium 160, reads the stored audio file, and transfers the read audio file to the audio codec 140. Then, the audio codec 140 extends (releases the compression of) the audio file transferred from the record medium interface 150 and restores the audio signals.

The audio output section 130 outputs the audio signals restored by the audio codec 140 to an embedded speaker (not shown) or a headphone (not shown) connected thereto and provides an audio to a user.

Alternatively, the record medium interface 150 accesses the record medium 160 and the read audio file name and the ID3 tag information of the audio file to the control section 180.

The display section 170 is a display device displaying the operation state of the reproducing apparatus, the menu screen, and the detailed information of the audio file, among others.

The control section 180 controls the overall operation of the reproducing apparatus according to a manipulation instruction of a user which is input through the manipulation section 190. The control section 180 displays the detailed information of the audio file on the display section 170 using a language which can be read by a user.

After the control section 180 selects a language of the ID3 tag information recorded in the audio file by analyzing the language of the audio file name and restores a letter string from the ID3 tag information on the audio file using a language code table on the selected language, the audio file name and/or the restored letter string is displayed on the display section 170 as the detailed information of the audio file.

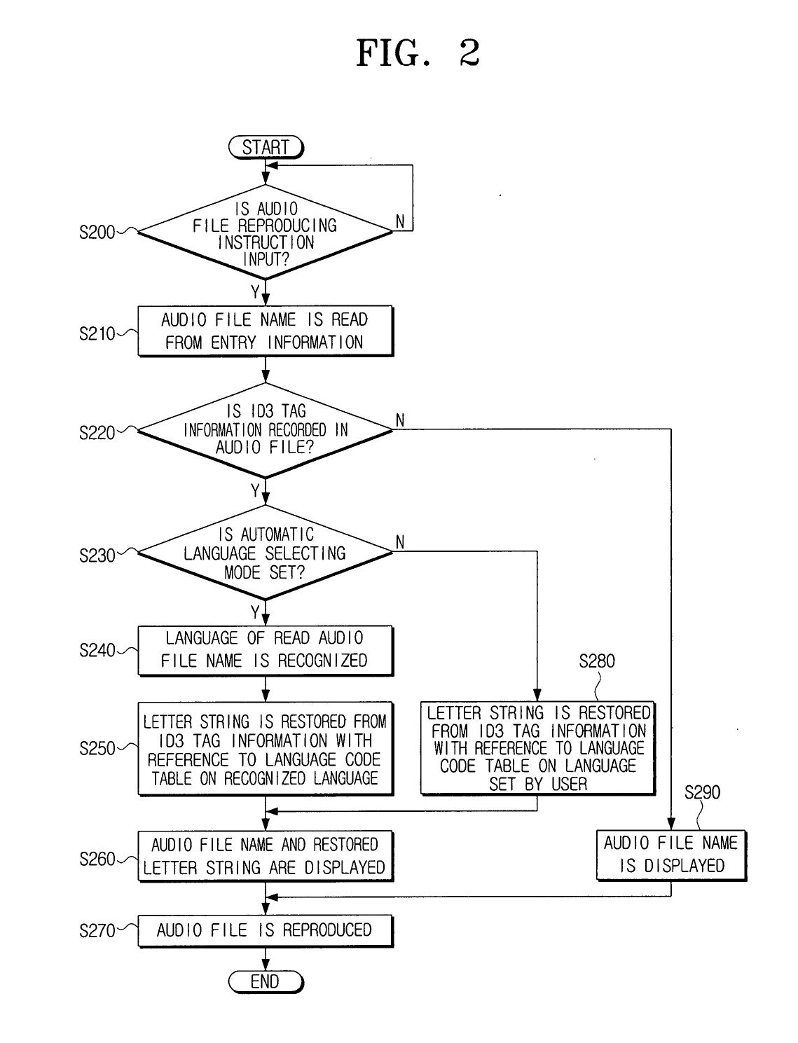

An exemplary embodiment of the present invention will be described in detail with reference to FIG. 2. FIG. 2 is a flow chart for explaining a method for providing audio file information according to an exemplary embodiment of the present invention.

As illustrated in FIG. 2, if an audio file reproducing instruction is input from a user through the manipulation section 190 (S200), the control section 180 reads an audio file name to be reproduced by an instruction from entry information of the record medium 160. (S210) More specifically, in S210, the record medium interface 150 reads the audio file name to be reproduced by the instruction from the entry information of the record medium 160 and the read audio file name is transferred to the control section 180.

Further, the control section 180 determines whether the ID3 tag information is recorded in the audio file to be reproduced by the instruction.

If a determination is made that the ID3 tag information is recorded in the audio file to be reproduced by the instruction in S220 (S220-Y), the control section 180 determines whether an automatic language selecting mode is set. (S230) The automatic language selecting mode is a mode in which the language of the ID3 tag information is not set manually by a user but automatically.

If a determination is made that the automatic language selecting mode is set in S230 (S230), the control section 180 recognizes the language of the audio file name which has been read in S210. (S240)

For the recognition of the language in S240, the control section 180 determines languages on letters constituting the audio file name, first. Since the audio file name is coded in the Unicode system, the control section 180 refers to a Unicode table in determining the possible languages based on the letters constituting the audio file name.

The control section 180 can recognize a language from the determined languages which is not English as the language of the audio file name. For example, if the audio file name includes four Korean letters and two English letters, then the control section 180 recognizes Korean as the language of the audio file name.

According to an exemplary implementation, the control section 180 restores a letter string from ID3 tag information of the audio file to be reproduced by an instruction with reference to a language code table corresponding to the recognized language in S240. According to an exemplary implementation, the ID3 tag information is read from the file to be reproduced by the instruction, which is stored in the record medium 160 by the record medium interface 150 and is transferred to the control section 180.

If the language recognized in S240 is Korean, the control section restores the letter string from the ID3 tag information transferred from the record medium interface 150 with reference to a Korean code table. Since an English code is included in the Korean code table, the control section 180 can restore the letter string from the ID3 tag information without difficulty. This happens even if an English code is included in the ID3 tag information in addition to a Korean code. Similarly, code tables for other languages can include codes from a from a second language.

Further, the control section 180 displays the audio file name read in S210 and the letter string restored in S250 as the detailed information of the audio file on the display section 170. According to an exemplary implementation, at S260, if music is determined to be recorded in the audio file, the control section 180 displays the audio file name as the music title on the display section 170 and displays the singer's name, the title of an album, and the year of production, among others of the information included in the ID3 tag information in the restored letter string on the display section 170.

According to an exemplary implementation, the control section 180 reproduces the audio file to be reproduced by an instruction. (S270) More specifically, in S270, the control section 180 controls the audio codec 140 to extend the audio file to be reproduced by an instruction which has been read from the record medium 160 by the record medium interface 150 to output the audio on the audio file extended in the audio output section 130.

Alternatively, if a determination is made that the automatic language selecting mode is not set in S230 (S230-N), the control section 180 restores the letter string from the ID3 tag information of the audio file to be reproduced by an instruction with reference to the language code table on the language set manually by a user and performs S260 and S270.

If it is determined that ID3 tag information is not recorded in the audio file to be reproduced by an instruction in S220, the control section 180 displays the file name which has been read in S210 on the display section 170. More specifically, the control section 180 displays the audio file name as the music title on the display section. Thereafter, S270 is performed.

The process by which the language of the ID3 tag information recorded in the audio file through the analysis of the audio file name is determined and the letter string is restored from the ID3 tag information of the audio file using the language code table on the determined language to automatically set the language of the ID3 tag information has been described above.

In S260 of the exemplary embodiment of the present invention, ‘the audio file name read in S210’ and ‘the letter string restored in S250’ have been mentioned as the detailed information of the audio file. However, the detailed information of the audio file may only include ‘the letter string restored in S250’. For example, the music title which is included in the ID3 tag information instead of the audio file name read in S210 can be displayed as the restored letter string on the display section 170 to represent the title of the music.

Alternatively, if all the letters constituting the audio file name are English letters in S240, the language of the audio file name may be recognized as English or one of the other languages. It is because an English code is included in all the language code tables. Therefore, it is preferable that the language of the ID3 tag information is continuously maintained as a preset language.

Further, it has been described that the ID3 tag information of the exemplary embodiment of the present invention is coded by the ISO-8859 code system. Therefore, if the ID3 tag information is coded by the Unicode system, letters may be restored from the ID3 tag information with reference to the Unicode table instead of a language code table of each language.

Although a process of displaying the detailed information of the audio file during ‘the reproduction of the audio file’ has been described, an exemplary embodiment of the present invention can be applied to an alternate case. This case differs from the case in which the audio file is reproduced. For example, the technical scope of an exemplary embodiment of the present invention may be applied if the detailed information of the audio file is displayed while providing an audio file list.

Alternatively, since the ID3 tag information mentioned in the exemplary embodiment of the present invention corresponds to an example of the additional information on the audio file, an exemplary embodiment of the present invention can be applied to the case in which additional information on the audio file is used instead of the ID3 tag information.

Further, the record medium 160 illustrated in FIG. 1 may be determined in contemplation of the specification and the volume of the reproducing apparatus. The record medium 160 may be 1) a semiconductor record medium such as an embedded memory (for example, a flash memory) embedded in the reproducing apparatus and a memory card (for example, a multimedia card (MMC) and a secure digital (SD) card) attachable to and detachable from the reproducing apparatus, 2) a magnetic record medium such as a hard disc drive (HDD), 3) an optical record medium such as a compact disc (CD), a digital versatile disc (DVD), a blue-ray disc (BD), and a high definition-DVD (HD-DVD).

If the record medium 160 is an embedded memory, the record medium interface 150 is realized by a memory controller controlling the read/write on the memory. If the record medium 160 is a memory card, the record medium interface 150 is realized by a memory card interface for accessing the memory card.

Further, if the record medium 160 is an HDD, the record medium interface 150 is realized by an HDD controller controlling the read/write on the HDD. If the record medium 160 is an optical record medium, the record medium interface 150 is realized by an optical record medium loader including an optical pick-up device.

Alternatively, the technical scope of an exemplary embodiment of the present invention may be applied to any file reproducing apparatus reproducing a file in which the contents such as a still image file and a moving image file are recorded in addition to an audio file.

An audio file reproducing apparatus reproducing an audio file and outputting an audio has been described and is merely an example of an exemplary embodiment of the present invention. Therefore, the technical scope may be applied to any file reproducing apparatus including a file reproducing apparatus (for example, a DMB player, a PDA, a motion picture player, an HDD player, a mobile phone, and a vehicular navigation) capable of reproducing and outputting a video file or a video/audio file, in addition to an audio file reproducing apparatus such as an MP3 player.

According to an exemplary embodiment of the present invention, the letter string is provided to a user as detailed information on the file. This occurs once a language of additional information on a file which is recorded in the file is determined through a language analysis of a file name and a letter string is restored from the additional information on the file using a language code table on the identified language. Accordingly, the detailed information on the file is prevented from being provided using a letter string which cannot be read by a user. This prevents user inconvenience which results from the user's language prediction on the detailed information to correct the problem.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing file information, the method comprising:
reading a file name of a file stored in a record medium;
recognizing a language of the read file name;
restoring a letter string from additional information on the file by referring to a language code table on the recognized language; and
displaying the restored letter string.

2. The method as claimed in claim 1, further comprising:
displaying the read file name as a title of contents recorded in the file.

3. The method as claimed in claim 2, wherein, in the displaying of a title, if a determination is made that there is no additional information in the file, the read file name is displayed as a title of the contents recorded in the file.

4. The method as claimed in claim 1, wherein, if a determination is made that there is the additional information in the file, one of the read file name and the title of the contents comprised in the additional information is displayed as the title of the contents recorded in the file.

5. The method as claimed in claim 1, wherein the file name is coded in a Unicode system and the additional information on the file is information coded in an ISO-8859 code system.

6. The method as claimed in claim 1, wherein the file is an audio file and the additional information on the file is ID3 tag information.

7. The method as claimed in claim 1, wherein, the recognizing of the language of the file name comprises determining languages of the letters constituting the file name, and recognizing a language of the determined languages which excludes English as the language of the file name.

8. A file reproducing apparatus comprising:
a record medium interface for accessing a record medium;
a display for displaying information; and
a control section for reading a file name of a file stored in a record medium through a record medium interface, recognizing a language of the read file name, restoring a letter string from additional information on the file by referring to a language code table on the recognized language, and displaying the restored letter string on the display.

9. The apparatus as claimed in claim 8, wherein the control section displays the read file name on the display as a title of contents recorded in the file.

10. The apparatus as claimed in claim 9, wherein, if a determination is made that there is no additional information in the file, the control section displays the read file name on the display as a title of the contents recorded in the file.

11. The apparatus as claimed in claim 8, wherein, if a determination is made that there is additional information in the file, the control section displays one of the read file name and the title of the contents comprised in the additional information on the display as the title of the contents recorded in the file.

12. The apparatus as claimed in claim 8, wherein the file name is coded in a Unicode system and the additional information on the file is information coded in an ISO-8859 code system.

13. The apparatus as claimed in claim 8, wherein the file is an audio file and the additional information on the file is ID3 tag information.

14. The apparatus as claimed in claim 8, wherein the control section determines languages of the letters constituting the file name and recognizes a language of the determined languages which excludes English as the language of the file name.
